(19) United States
(12) Patent Application Publication
(10) Pub. No.: US 2024/0199989 A1
(43) Pub. Date: Jun. 20, 2024

(54) SOAP BAR

(71) Applicant: Conopco, Inc., d/b/a UNILEVER, Englewood Cliffs, NJ (US)

(72) Inventors: Luciane Cristina BIGARAN, Campinas (BR); Erika CASTANHO AMADEU, Serra Negra (BR); Mariangela GOMES DE OLIVEIRA SICHMANN, Redondo Beach, CA (US)

(73) Assignee: Conopco, Inc., d/b/a UNILEVER, Englewood Cliffs, NJ (US)

(21) Appl. No.: 18/288,114

(22) PCT Filed: Apr. 5, 2022
(86) PCT No.: PCT/EP2022/058937

§ 371 Date: Oct. 24, 2023

(30) Foreign Application Priority Data
May 3, 2021 (EP) 21171818.4

(51) Int. Cl. C11D 3/20; C11D 13/18; C11D 17/00

(52) U.S. Cl. CPC C11D 3/2075; C11D 13/18; C11D 17/0047

(57) ABSTRACT

The present invention relates to the process to manufacture a soap bar composition containing 10-40 wt % lauric acid soap, based on the weight of the fatty acid soap, the bar comprising glycerol and free fatty acids.

### FIELD OF THE INVENTION

The present invention relates to the process to manufacture a soap bar composition. It further relates to a soap bar composition.

### BACKGROUND OF THE INVENTION

There are many categories of products in the personal wash market e.g. body wash, face wash, hand wash, soap bars, shampoos etc. Products which are marketed as body wash, face wash and shampoos are generally in liquid form and are made of synthetic anionic surfactants. They are sold in plastic bottles/containers. Soap bars and hand wash products generally contain soaps. Soap bars do not need to be sold in plastic containers and are able to retain their own shape by virtue of being structured in the form of a rigid solid. Soaps bars are usually sold in cartons made of cardboard or in a plastic pack.

A known desire in cleansing bars is a rich and creamy lather formation. It is furthermore desired that the soap bar has sufficient hardness to be able to be manufactured on industrial scale. The risk of cracking of the bar upon storage/during usage should be as low as possible. Several soap bars are presently marketed which provide this attribute.

One of the predominant components in a soap bar is soap. Classic soap production involved the saponification of fat or oil into free fatty acid residues (monocarboxylic acids) and glycerol. The presence of alkali results in the formation of salt of the fatty acids, which is known as soap. Also, free fatty acids can be transformed into soap by treatment with alkali. Especially lauric acid soap is desired in soap bars, as it provides a rich lather.

However, the presence of lauric acid soap in the total soap mass comes with drawbacks. For example, the ingredient mixture becomes relatively soft when fatty C₈-C₁₄ soap, such as C₁₂ fatty acid soap, is present. In addition, a soap bar with a high amount of lauric acid soap is relatively expensive. A soft ingredient mixture may give complications in manufacturing.

Soap bars are generally prepared through one of two routes. One is called the cast bar route while the other is called the milled and plodded route, also known as the ‘extruded route’. The cast bar route has inherently been very amenable in preparing low TFM (total fatty matter) bars. Total fatty matter is a common way of defining the quality of soap. It is defined as the total amount of fatty matter, mostly fatty acids, that can be separated from a sample of soap after splitting with a mineral acid, usually hydrochloric acid. In the cast bar soaps, the soap mixture is mixed with polyhydric alcohols and the hot/melted mixture is poured in casts and allowed to cool and then the soap bars are removed from the casts. The cast bar route is also the route typically used to prepare translucent bars. The cast bar route enables production at relatively lower throughput rates.

Conventionally, milled and plodded soaps are made by a process comprising saponification of fat and oils, forming the dried soap into noodles, mixing the various desired additives such as colorants, perfume, etc., into the soap noodles, passing the mixture formed through a mill or series of mills (“milling” the soap) thereby forming ribbons of soap, passing the milled soap mixture through a plodder to form billets of soap (i.e., “plodding” the soap, and cutting the billets into segments and stamping the segments into the desired shape.

A soap noodle with a high level of lauric fatty acid in the composition of the soap noodles does not allow an effective soap extrusion. The mass of soap bar becomes very soft and does not allow extrusion in current process parameters/equipment. As a comparison, a conventional soap noodle comprises for example 80 wt % soap derived from palm oil (rich in C₁₆-C₁₈) and 20 wt % soap derived from palm kernel oil (rich in C₁₂), based on total soap noodle weight, and a C₁₂ soap level of about 10-15 wt %

Therefore, there is a desire for a bar composition wherein the amount of lauric acid soap, is relatively low, but which still provides rich and creamy lather production upon use, preferably to the extend comparable to bar compositions comprising relatively high levels of lauric acid soap. It is further desired, that such bar compositions can be prepared using conventional efficient industrial production machinery with high through-put that involves extrusion of a soap base ingredients mixture. Preferably the bars have a low risk on cracking upon storage/during usage. The bar is preferably translucent.

### SUMMARY OF THE INVENTION

Surprisingly, it was found that with the use of free fatty acids and glycerin in specific amounts, a soap bar composition could be prepared with abundant lather and hardness, and with a good production efficiency.

Accordingly, in a first aspect, the invention relates to a process to produce a soap bar composition, the process comprising the steps of:
a) Providing a mixture comprising:
   Fatty acid soap in an amount of from 60 to 85% (preferably 65 to 80 wt %, more preferably 68 to 75 wt %), based on the weight of the resulting soap bar,
      wherein the amount of C₈ to C₁₄ fatty acid soap (often referred to as “lauric portion”) is between 10 and 40 wt %, preferably between 15 and 30 wt %, based on the total weight of the fatty acid soap,
   Free fatty acids in an amount of from 0.5 to 5 wt %, preferably from 1 to 4 wt %, based on the weight of the resulting soap bar, wherein the added free fatty acids comprise C₁₂ free fatty acid in an amount of from 40 to 100 wt %, preferably from 60 to 100 wt %, even more preferably from 80 to 100 wt %, most preferably 100%, based on the weight of the added free fatty acids,
   Glycerol, in an amount of from 2.5 to 6.5 wt %, preferably of from 3 to 5 wt %, based on the weight of the resulting soap bar,
   10 to 25 wt % of water, preferably from 15 to 20 wt %, based on the weight of the resulting soap bar,
b) shaping the mixture resulting from step b) into a soap bar.

In a second aspect, the present invention relates to a soap bar comprising:
60 to 85% of fatty acid soap, preferably 65 to 80 wt %, more preferably 68 to 75 wt %, wherein the amount of C₈ to C₁₄ fatty acid soap is between 10 and 40 wt %, preferably between 15 and 30 wt %, based on the total weight of the fatty acid soap,
0.5 to 5 wt % of free fatty acids, preferably from 1 to 4 wt %, wherein the composition comprises C₁₂ free fatty acid in an amount of from 40 to 100 wt %, based on the weight of the free fatty acid.
2.5 to 6.5 wt % of glycerol,
10 to 25 wt %, preferably from 15 to 25 wt % of water.

In a third aspect, the invention relates to the use in a soap bar of
0.5 to 5 wt %, preferably 1 to 4 wt % of free fatty acids, based on the weight of the resulting soap bar, wherein C₁₂ free fatty acid is added in an amount of from 40 to 100 wt %, based on the weight of the free fatty acid, and
2.5 to 6.5 wt %, preferably of from 3 to 5 wt % of glycerol, based on the weight of the resulting soap bar,
   to increase lather from the soap bar upon use thereof, the soap bar comprising
60 to 85 wt % of fatty acid soap, preferably 65 to 80 wt %, more preferably 68 to 75 wt %, wherein the amount of C₈ to C₁₄ fatty acid soap is between 10 and 40 wt %, preferably between 15 and 30 wt %, based on the total weight of the fatty acid soap.

In a fourth aspect, the invention relates to the use in a soap bar of
0.5 to 5 wt %, preferably 1 to 4 wt % of free fatty acids, based on the weight of the resulting soap bar, wherein C₁₂ free fatty acid is added in an amount of from 40 to 100 wt %, based on the weight of the free fatty acid, and
2.5 to 6.5 wt %, preferably of from 3 to 5 wt % of glycerol, based on the weight of the resulting soap bar,
   to increase the hardness of the soap bar, the soap bar comprising
60 to 85 wt % of fatty acid soap, preferably 65 to 80 wt %, more preferably 68 to 75 wt %, wherein the amount of C₈ to C₁₄ fatty acid soap is between 10 and 40 wt %, preferably between 15 and 30 wt %, based on the total weight of the fatty acid soap.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description and claims indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The present invention relates to a process to prepare a soap bar composition comprising: 0.5 to 5 wt % of free fatty acids wherein 40 to 100 wt % thereof is lauric acid, and 2.5 to 6.5 wt % of glycerol and 10 to 40 C₈ to C₁₄ fatty acid soap, based on the weight of total soap in the composition, and to the soap bar resulting thereof.

The invention relates to a soap bar composition comprising:
60 to 85% of fatty acid soap, preferably 65 to 80 wt %, more preferably 68 to 75 wt %, wherein the amount of C₈ to C₁₄ fatty acid soap is between 10 and 40 wt %, preferably between 15 and 30 wt %, based on the total weight of the fatty acid soap,
0.5 to 5 wt % of free fatty acids, wherein the composition comprises C₁₂ free fatty acid in an amount of from 40 to 100 wt %, based on the weight of the free fatty acid.
2.5 to 6.5 wt % of glycerol,
10 to 25 wt %, preferably from 15 to 25 wt % of water.

It was a surprising finding of the present invention that the combination of 0.5 to 5 wt % of free fatty acids wherein 40 to 100 wt % thereof is lauric acid, and 2.5 to 6.5 wt % of glycerol, in a soap bar composition comprising 10 to 40 wt % C₈ to C₁₄ fatty acid soap (based on total soap weight in the bar) results in a bar with a desired hardness of the soap bar composition, and allowing stamping of the soap bar composition, thereby providing high-throughput production.

### Soap

The term soap means salt of fatty acids. By a soap bar composition is meant a cleansing composition comprising soap which is in the form of a shaped solid. The soap content of the composition of the invention is from 60 to 85 wt %, more preferably between 65 to 80 wt %, and most preferably 68 to 75 wt % based on weight of the composition.

Preferably, the soap is soap of C₈ to C₂₄ fatty acids, more preferably of C₁₀ to C₁₈ fatty acids. According to the invention, the amount of C₈ to C₁₄ fatty acid soap (often referred to as “lauric portion”) is of from 10 to 40 wt %, preferably of from 15 to 30 wt %, based on weight of total soap in the composition. The soap preferably contains C₁₂ fatty acid soap in an amount of from 4.8 to 19.2 wt %, preferably 7.2 to 14.4 wt %, based on the weight of the total fatty acid soap content. Preferably, the amount of non-lauric soap (soap not being C₈ to C₁₄ soap) is from 60 to 90 wt %, preferably of from 70 to 85 wt %, based on the total weight of the soap in the composition. Accordingly, it is preferred that the amount of C₁₆ to C₁₈ fatty acid soap (often referred to as “non-lauric portion”) is from 60 to 90 wt %, preferably of from 70 to 85 wt %, based on the total weight of the soap in the composition.

The cation of the soap may be an alkali metal, alkaline earth metal or ammonium ion, preferably alkali metal cation. Preferably, the cation is selected from sodium or potassium, more preferably sodium. The soap may have saturated and/or unsaturated fatty acids. Soaps with higher content of saturated fatty acid soaps, preferably more than 50% are preferred over soaps with higher content of unsaturated fatty acid soaps for stability. The oil or fatty acids may be of vegetable or animal origin.

The soap may be obtained by saponification of oils, fats or fatty acids. The fats or oils generally used to make the shaped solid cleansing compositions may be selected from tallow, tallow stearins, palm oil, palm stearins, soya bean oil, fish oil, castor oil, rice bran oil, sunflower oil, coconut oil, babassu oil, and palm kernel oil. The fatty acids may be from coconut, rice bran, groundnut, tallow, palm, palm kernel, cotton seed or soyabean. Preferably the fatty acid soap comprises soaps derived from palm oil and palm kernel oil. To obtain translucency typically is a problem in soaps derived from palm oil and palm kernel oil. It is preferred, that the fatty soap derived from palm kernel oil is 10 to 40 wt %, preferably 15-30 wt %, based on the weight of the total fatty acid soap. Preferably 60 to 90 wt %, more preferably 70 to 85 wt %, based on the weight of the total fatty acid soap content is soap derived from palm oil. The soaps may also be synthetically prepared (e.g. by the oxidation of petroleum or by the hydrogenation of carbon monoxide by the Fischer-Tropsch process). Resin acids, such as those present in tall oil, may also be used. Naphthenic acids may also be used.

The soap bar may additionally comprise synthetic surfactants selected from one or more from the class of anionic, non-ionic, cationic or zwitterionic surfactants, preferably from anionic surfactants. These synthetic surfactants, as per the present invention, are included in less than 8%, preferably less than 4%, more preferably less than 1% and optimally absent from the composition.

The soap bar composition generally comprises electrolyte and water. Electrolytes as per this invention include compounds that substantially dissociate into ions in water.

Electrolytes as per this invention are not an ionic surfactant. Suitable electrolytes for inclusion in the soap making process are alkali metal salts. Preferred alkali metal salts include sodium sulfate, sodium chloride, sodium acetate, sodium citrate, potassium chloride, potassium sulfate, sodium carbonate and other mono or di or tri salts of alkaline earth metals, more preferred electrolytes are sodium chloride, sodium sulfate, sodium citrate, potassium chloride and especially preferred electrolyte is sodium chloride sodium sulphate, sodium citrate or a combination thereof. For the avoidance of doubt, it is clarified that the electrolyte is a non-soap material. Electrolyte is preferably included in 0.4 to 6%, preferably 1 to 3% by weight of the composition.

Water is used as the slurrying medium for the soap and is preferably included in 15 to 21% by weight of the bar composition.

### Glycerol

It was surprisingly found, that the combination of free fatty acids and glycerol resulted in a significant increase in lather. An increase of FFA alone, with a glycerol level below the minimum amount as claimed, did not provide the effect on lather.

It had been found, that the weight ratio of glycerol to total free fatty acids in the bar is preferably below 5, preferably higher than 1 and lower than 5, preferably from 1.5 and 4.5, more preferably of from 2 to 4. These ratios are preferably used in the mixture of step b) of the process.

The glycerol in the composition preferably ranges from 2.5 to 6 wt %, more preferably in the range of 3 wt % to 5 wt %, based on the weight of the bar composition. These amounts are preferably used in the mixture of step b) of the process.

The total polyol level in the bar composition of the invention is preferably 2.5 to 6 wt %. Glycerol preferably is the only polyol present in the bar.

### Free Fatty Acids

Free fatty acids (FFA) are present in an amount of from 0.5 to 5 wt %, preferably in an amount of from 1 to 4 wt %, even more preferably of from 1.5 to 3 wt % based on the weight of the bar composition. The bar composition comprises C₁₂ free fatty acid in an amount of from 40 to 100 wt %, more preferably 60 to 80 wt %, based on the weight of the free fatty acid. Most preferably, 100% of the free fatty acid in the composition is C₁₂.

Most preferably, the composition comprises C₁₂ free fatty acid in an amount of from 0.5 to 5 wt %, more preferably 1 to 4 wt % and most preferably 1.5 to 3 wt %, based on the weight of the composition. These are the preferred amounts that are added in step b) of the process.

Addition of FFA in combination with glycerol counterintuitively had an increasing effect on the hardness of the soap bars, as addition of FFA on its own does not have this effect or may even reduce the hardness of bars.

### Water

The composition includes 10 to 25 wt % water; more preferably 12 to 22, even more preferably 16 to 20 wt % and most preferably 15 to 17 wt % water based on the weight of the bar composition. Water is added in step b) of the process in these amounts.

### Organic and Inorganic Adjuvant Materials

The total level of the adjuvant materials used in the bar composition preferably is in an amount not higher than 50%, preferably 1 to 50%, more preferably 3 to 45% by weight of the soap bar composition.

It may be preferred, that if an adjuvant material is present, that starchy materials may be present in the bar composition. However, it is more preferred in the present invention, that the bar is free from starch.

### Opacifier

It may be preferred, that the bar of the present invention is opaque. Especially in that situation, the bar composition may preferably comprise an opacifier. When opacifiers are present, the shaped solid cleansing composition is generally opaque, i.e. “opacification”. Examples of preferred opacifiers include titanium dioxide, zinc oxide, ethylene glycol mono- or di-stearate or zinc stearate. A particularly preferred opacifier that can be employed when an opaque rather than a transparent soap composition is desired is ethylene glycol mono- or di-stearate, for example in the form of a 20% solution in sodium lauryl ether sulphate. An alternative opacifying agent is zinc stearate.

It may however be more preferred, that the bar is a translucent bar. Even more preferred the translucent soap bar composition is a water-clear translucent solid cleansing composition. In case of a translucent soap bar composition, it will preferably not contain an opacifier It may be preferred that the bar composition is free from titanium dioxide, zinc oxide, ethylene glycol mono- or di-stearate or zinc stearate. Preferably, the bar is free from TiO2, polyox high molecular weight or mixture thereof. Even more preferably, the bar is free from talc, TiO2, polyox high molecular weight or mixture thereof. Preferably the bar is a translucent bar. Translucent allows some, but not all, light to pass through it. Preferably more than 20%, even more preferably more than 25%, even more preferably more than 30% and even more preferably more than 40% of light passes through. In an opaque bar, no light passes through.

It can be desired to use a filler in the soap composition, such as talc. If present, talc is preferably present in an amount of from 1 to 8 wt %, preferably of from 1.5 to 4 wt %.

The pH of preferred soaps bars of the invention is from 8 to 11, more preferably 9 to 11.

A preferred bar may additionally include up to 30 wt % benefit agents. Preferred benefit agents include moisturizers, emollients, sunscreens and anti-ageing compounds. The agents may be added at an appropriate step during the process of making the bars. Some benefit agents may be introduced as macro domains.

Other optional ingredients like anti-oxidants, perfumes, polymers, chelating agents, colourants, deodorants, dyes, emollients, moisturizers, enzymes, foam boosters, germicides, additional anti-microbials, lathering agents, pearlescers, skin conditioners,

stabilisers, superfatting agents, sunscreens may be added in suitable amounts in the process of the invention. Preferably, the ingredients are added after the saponification step. Sodium metabisulphite, ethylene diamine tetra acetic acid (EDTA), borax or ethylene hydroxy diphosphonic acid (EHDP) are preferably added to the formulation.

According to another aspect of the present invention, there is provided use of a composition for providing enhanced perfume impact or enhanced deposition of actives.

### Process

The invention relates in a further aspect to a process to produce a soap bar composition according to the invention, the process comprising the steps of:
a) Providing a mixture comprising:
   60 to 85% of fatty acid soap (preferably 65 to 80 wt %, more preferably 68 to 75 wt %), based on the weight of the resulting composition,
      wherein the amount of C₈ to C₁₄ fatty acid soap is between 10 and 40 wt %, preferably between 15 and 30 wt %, based on the total weight of the fatty acid soap,
   0.5 to 5 wt %, preferably 1 to 4 wt % of free fatty acids, wherein the resulting composition comprises C₁₂ free fatty acid in an amount of from 40 to 100 wt %, based on the weight of the free fatty acid.
   2.5 to 6.5 wt %, preferably of from 3 to 5 wt % of glycerol, based on the weight of the resulting composition,
   10 to 25 wt % of water, based on the weight of the resulting composition,
b) shaping the mixture of step a) into a bar.

In step a) of the process according to the invention fatty acid soap is used. The fatty acid soap used is in solid form. The fatty acid soap is conventionally added in particles comprising the fatty acid soap. Such particles are commonly referred to as ‘soap noodles’. Accordingly, preferably the fatty acid soap is provided in the form of soap noodles. Preferably the fatty acid soap, such as preferably provided in the form of soap noodles, comprises soaps derived from palm oil and palm kernel oil. It is preferred, that the fatty soap derived from palm kernel oil is 10 to 40 wt %, preferably 15-30 wt %, based on the weight of the total fatty acid soap. Preferably 60 to 90 wt %, more preferably 70 to 85 wt %, based on the weight of the total fatty acid soap content is soap derived from palm oil. The amount of C₈ to C₁₄ fatty acid soap is between 10 and 40 wt %, preferably between 15 and 30 wt %, the amount of soap not being C₈-C₁₄, preferably C₁₆-C₁₈ soap, preferably is from 60 to 90 wt %, preferably of from 70 to 85 wt %, based on the weight of the total fatty acid soap. The fatty acid soap preferably contains C₁₂ fatty acid soap in an amount of from 4.8 to 19.2 wt %, preferably 7.2 to 14.4 wt %, based on the weight of the total fatty acid soap content. Soap noodles can be provided commercially or prepared by the skilled person. It is preferred, that in the process of the invention, the soap noodles, comprising the fatty acid soap, used in step a), comprise a low glycerol content. The glycerol level of the soap noodles is preferably less than 8 wt %, preferably the glycerol level is below 3 wt %, even more preferably it is of between 0 and 2.5 wt %, based on the weight of the soap noodles. This glycerol level in the soap noodles is achieved by removal of glycerol from the reaction mixture after formation of soap from fat. After the saponification, glycerol remains normally present in the soap mass and ends up in the soap noodle. In the present invention, preferably fatty acid soap is provided with soap noodles wherein glycerol has been removed to a significant extent. Low glycerol soap noodles can alternatively be prepared by saponification of fatty acids, rather than oil.

The soap noodles have preferably less than 5, preferably less than 1 more preferably less than 0.5 wt % of FFA and are most preferably free from free fatty acids. It may be preferred hat the soap noodles are free from water.

Accordingly, it is preferred that the process according to the invention comprises the step of providing solid fatty acid soap noodles comprising less than 8 wt %, preferably less than 3 wt %, preferably from 0 to 2.5 wt % of glycerol. This preferred step is carried out before step a). Glycerol is then added in the next step, wherein a mixture is provided with the fatty acid soap, preferably comprised in soap granules, such as soap noodles, and further with free fatty acids, said glycerol, and water.

Accordingly, it is preferred, that the process of the invention comprises the steps of:
a) Providing a mixture comprising the following ingredients, by mixing:
   Fatty acid soap, in an amount of from 60 to 85% (preferably from 65 to 80 wt %, more preferably from 68 to 75 wt %), based on the weight of the resulting soap bar, wherein the amount of C₈ to C₁₄ fatty acid soap is between 10 and 40 wt %, (preferably between 15 and 30 wt %), based on the total weight of the fatty acid soap, and wherein the fatty acid soap is added in the form of soap noodles comprising the fatty acid soap, wherein the soap noodles comprise less than 8 wt % of glycerol, based on the weight of the soap noodles, preferably less than 3 wt %, preferably from 0 to 2.5 wt %,
   Free fatty acids in an amount of from 0.5 to 5 wt %, preferably from 1 to 4 wt %, based on the weight of the resulting soap bar, wherein the added free fatty acids comprise C₁₂ free fatty acid in an amount of from 40 to 100 wt %, preferably from 60 to 100 wt %, even more preferably from 80 to 100 wt %, most preferably 100%, based on the weight of the added free fatty acids,
   Glycerol, in an amount of from 2.5 to 6.5 wt %, preferably of from 3 to 5 wt %, based on the weight of the resulting soap bar,
   10 to 25 wt % of water, preferably from 15 to 20 wt %, based on the weight of the resulting soap bar,
b) shaping the mixture resulting from step b) into a soap bar.

The free fatty acids are added in an amount of from 0.5 to 5 wt % based on the weight of the mixture, i.e. based on the weight of the resulting soap bar. Preferred amounts are from 1 to 4 wt %. C₁₂ free fatty acid is preferably added in an amount of from 0.5 to 5 wt %, preferably of from 1 to 4 wt % based on the weight of the resulting soap bar. C₁₂ free fatty acid accordingly comprises preferably from 40 to 100 wt % of the weight of added free fatty acid. The free fatty acids are added as an ingredient as such and can be in the form of FFA flakes or liquid. Preferably, the FFA are added in the form of a liquid.

The water is added in an amount of preferably 10 to 25 wt %, more preferably of from 15 to 20 wt % and even more preferably of from 15 to 17 wt %, based on the weight of the mixture of step b). Accordingly, these amounts of water are also based on the weight of the resulting soap bar.

The mixture is preferably prepared within a total mixing time of between 9-20 minutes, preferably 9-15 minutes, preferably 10 to 14 minutes, which is a conventional mixing time in the art. The temperature of the mixture is preferably of between 35 and 48° C., and preferably of between 40 and 46° C. for optimal results. The higher temperatures resulted in higher translucency.

Glycerol is preferably added in the step of the process wherein the mixture is made comprising fatty acid soap, free fatty acids, glycerol and water, i.e. step a), in a total glycerol amount of from 2.5 to 6 wt %, based on the weight of the mixture of step b). Accordingly, such amounts represent the amounts of glycerol based on the weight of the resulting soap bar. Preferably the total amount of glycerol is from 3 to 5 wt %, based on the weight of the resulting soap bar. It may be preferred, that when preparing the ingredient mixture, glycerol is added after the fatty acid soap, preferably before the free fatty acids and water are added thereto. Adding the glycerol before the free fatty acids and water, preferably as the first ingredient after the fatty acid soap, typically added as soap noodles, surprisingly proved to have a beneficial effect on the appearance of the resulting soap bar, that appeared to be much more translucent. Translucent bars could now be produced in an efficient manner, e.g. compared to cast melt bars, in a high throughput process, within a similar time as used for opaque bars.

In step c) of the process of the invention, the mixture resulting from step b) is shaped into a bar. The shaping preferably comprises extrusion of the mixture, preferably followed by cutting the extruded material into individual soap bars. The soap composition may be made into a bar by a process that includes extruding the mixture in a conventional plodder. The bars preferably have a size of between 10 and 14 cm. They have preferably a weight of from 70 to 160 grams, preferably of from 73-to 75 grams.

Alternatively, shaping takes place in the form of stamping the material in a desired shape, for example by stamping it in a mould.

The process may further include the step of stamping indicia onto the surface of the bar.

The invention further relates to a soap bar obtainable by, preferably obtained by the process of the present invention.

The invention further relates to the use of
0.5 to 5 wt %, preferably 1 to 4 wt % of free fatty acids, based on the weight of the resulting composition, wherein C₁₂ free fatty acid is added in an amount of from 40 to 100 wt %, based on the weight of the free fatty acid, and
2.5 to 6.5 wt %, preferably of from 3 to 5 wt % of glycerol, based on the weight of the resulting composition,
   to increase lather in a soap bar comprising
60 to 85% of fatty acid soap (preferably 65 to 80 wt %, more preferably 68 to 75 wt %), wherein the amount of C₈ to C₁₄ fatty acid soap is between 10 and 40 wt %, (preferably between 15 and 30 wt %), based on the total weight of the fatty acid soap.

Furthermore, the invention relates to the use in a soap bar of
0.5 to 5 wt %, preferably 1 to 4 wt % of free fatty acids, based on the weight of the resulting soap bar, wherein C₁₂ free fatty acid is added in an amount of from 40 to 100 wt %, based on the weight of the free fatty acid, and
2.5 to 6.5 wt %, preferably of from 3 to 5 wt % of glycerol, based on the weight of the resulting soap bar,
   to increase the hardness of a soap bar, the soap bar comprising
60 to 85 wt % of fatty acid soap (preferably 65 to 80 wt %, more preferably 68 to 75 wt %), wherein the amount of C₈ to C₁₄ fatty acid soap is between 10 and 40 wt %, (preferably between 15 and 30 wt %), based on the total weight of the fatty acid soap.

Lather and hardness of the bar respectively is increased compared to an equivalent soap bar wherein the FFA and glycerol are not added.

It was found that with the combination of free fatty acids and glycerol a bar composition could be provided that allowed for a reduction in C₈ to C₁₄ fatty acid soap including lauric acid soap while still providing a high lather. The bar of the invention shows the advantage that the bar is easy to extrude, despite its relatively low level of C₈ to C₁₄ fatty fatty acid soap of between 10 and 40 wt % based on the total weight of the fatty acid soap. By “easy to extrude” is meant that the hardness of the bar as it is extruded is high enough that it exits the extruder in a firm enough form that it can be called a rigid bar. The hardness of the bar as measured directly after extrusion is preferably higher than 1.2 kg, more preferably in the range of 1.2 to 5.0 kg and even more preferably of from 2.7 to 4.7 kg (at 40° C.). The hardness is preferably measured using the TA-XT Express apparatus available from Stable Micro Systems. The hardness is measured using this apparatus with a 30° conical probe—Part #P/30c to a penetration of 15 mm. If the soap mass is too soft and is passed through the extruder it will not extrude out of the extruder in a cohesive enough mass to be called a bar. By “easy to stamp” is meant that the soap bar is of such a consistency and low enough stickiness that it does not stick to the die that is used to stamp any desired indicia on the bar. The soap bar prepared by the process of the invention therefore preferably comprises an indicium stamped thereupon.

The lather is preferably of from 300 to 430 ml and measured in mL of lather volume.

The invention will now be exemplified by the following non-limiting examples:

### EXAMPLES

### Example 1

The following soap bar compositions were prepared as shown in Table 1:

| | | | | Comparative |
|---|---|---|---|---|
| | Example | Example | Example | example |
| | 1 | 2 | 3 | 4 |
| Ingredient | (wt %) | (wt %) | (wt %) | (wt %) |
| Soap noodles* | 78 | 74.7 | 63.9 | 77.6 |
| wt % C₈-C₁₄ soap | 20 | 20 | 20 | 20 |
| in the soap | | | | |
| PKO soap** | | | 15 | |
| Water | 16 | 16 | 16 | 16 |
| Total glycerol (incl. 2 | 3.3 | 5 | 3.3 | 2 |
| wt % from noodles) | | | | |
| EDTA, EDHP | 0.14 | 0.14 | 0.14 | 0.14 |
| Lauric acid C12 (%) | | 3 | | |
| flakes (FFA) | | | | |
| Coconut FFA (liquid) | 1.5 | | 0.5 | 0.5 |
| Talc | | | | 2 |
| Polyox N 60K | | | | 0.03 |
| TiO2 | | | | 0.45 |
| fragrances | 1.1 | 1.1 | 1.1 | 1.26 |
| colorants | 0.003 | 0.003 | 0.003 | 0.06 |
| extracts | 0.01 | 0.01 | 0.01 | 0.01 |
| Ratio glycerol/FFA | 2.2 | 1.7 | 6.6 | 4 |
| Total C12 soap | 15.6 | 14.9 | 12.8 | 15.5 |

*soap is prepared from the fatty acids of palm oil (80 wt %) and palm kernel oil (20 wt %) and contains 2 wt % of glycerol.
**Added in addition to the soap noodles and this is added in the mixture after the glycerol.

For examples 1-3, fatty acid soap noodles were provided wherein the glycerol level was 2 wt %. An ingredient mixture was provided according to the table above. Ingredient mixtures where prepared by adding the glycerol as a first ingredient after the soap noodles in the mixing vessel. Mixing of the glycerol with soap oodles took 2-3 minutes. This was followed by the water and colorants and then the FFA and fragrances. Total preparation of the mixture, i.e. total mixing time was 10-14 minutes. The temperature of the mixture was 40-42° C. The mixtures were extruded through a plodder and stamped to provide a bar. For comparative example 4, soap noodles were used comprising 2 wt % glycerol, and no post addition of glycerol was done.

### Description of the Results:

| | | | | | Comparative |
|---|---|---|---|---|---|
| | | | | | example 5 |
| | Example | Example | Example | Comparative | 100% PKO |
| | 1 | 2 | 3 | example 4 | soap bar |
| Hardness of bar | hard | hard | hard | Hard | soft |
| | (3.9 kg) | (3.0 kg) | (4.2 kg) | | |
| Speed of lather | fast | fast | fast | Slightly fast: | Moderate |
| formation | | | | | |
| Lather volume | 370 | 372 | 412 | 288 | 317 |
| Appearance | translucent | translucent | translucent | opaque | Semi-translucent |

Comparative example 5 represents a prior art bar with 100% PKO soap (high C₁₂ fatty acid soap). As expected, such a bar shows a high amount of lather (317 ml), however the soap ingredient mixture is too soft, which resulted in problems with the equipment, requirements to adjust pressing parameters and a much lower throughput of bars. The bar is semi-translucent, almost opaque. It was found that in a bar with a significantly lower lauric acid soap content, (e.g. 20% of total soap), the hardness could be restored, but the lather is reduced significantly (Comparative example 4). When the combination was used of glycerol and free fatty acid in amounts according to the invention, the shortcomings of prior art bars were overcome: The examples 1-3 show significantly higher lather volume, a faster lather formation, and allow extrusion and stamping at efficient speed during production. Lather formation was improved without a negative impact on hardness, and the machinery didn't need to be changed. As a consequence of the production process, post-adding glycerol as the first ingredient after the noodles in the mixture, the bars were more translucent. Their translucency was better than that of comparative example 4 (opaque bar) and than that of the prior art bar (comparative example 5).

### Test Methods in the Present Invention

### Lather Volume

### 1. Principle

The amount of lather generated by toilet bar is an important parameter affecting consumer preference. The lather volume test described here gives a quantitative measure of lather generation under standard conditions, thus allowing objective comparison of different soap formulations.

Lather is generated by trained technicians using a standardised method. The lather is collected in a beaker, and its volume measured.

This procedure may be conducted by trained and experienced technicians, capable to discriminate and reproduce results from a range of different formulation types, with replicates within variation ±10 mL.

It is recommended 8-12 answers for each product tested. So, tests can be done by 3-4 technicians, each making duplicate or triplicate determinations. For each test made by each technician a different random order of testing the bars should be used.

Results are reported by data average and standard deviation. It is not recommended statistical analysis due to low amount of answers. But, based on deviation of analysis+correlation to consumers' data, differences higher than 20 mL among products can be considered significant.

### 2. Equipments/Facilities Setup/Samples

| | |
|---|---|
| Washing up bowl | 1 per operator capacity 10 liters |
| Soap drained dishes | 1 per sample |
| Surgical latex gloves | sizes to fit each technicians |
| Beaker | 500 mL, 10 mL graduated, 8 cm diameter |
| Thermometer | Mercury types are not approved |
| Plastic stick | Sufficiently long to allow stirring in |
| | the beaker |
| Water temperature set-up | 30° C. (Tests can be done at more than |
| | one temperature) |
| Water hardness set-up | accordingly to region under study (see |
| | Appendix 1) |
| Metronome (optional) | 150 bpm |
| Samples | 1 bar per replicate per evaluator (8-12 |
| | bars), of each product tested |

### 3. Procedure

a) Identify all samples on soap dishes with correct codes, accordingly to test form.
b) Before start the test, wearing gloves, wash well the hands with neutral soap (e.g. a cast melt product or SLS solution 4%). Then, wash down all test samples spinning them 20 times* under running water.
   1 spin=180° turn on speed of 1 bit in the metronome rhythm 150 bpm.
c) Place about 5 liters of water of known hardness and at a specified temperature in a bowl. Change the water after each sample has been tested.
d) Take up the bar, dip it in the water and remove it. Spin the bar 15 times*, between the hands. Place the bar on the soap dish.
e) Gather lather generated, and rub one hand over the other hand 10 times** in the same way.
   *1 rub=back and forth movement in the metronome rhythm 150 bpm. 1 bit for back, and other bit for forth movement.
f) Grip the right hand with the left, or vice versa, and force the lather to the tips of the fingers. Do this procedure 5 times changing hands in each movement.
g) Rub one hand over the other hand 10 times** in the same way again.
h) Again, grip the right hand with the left, or vice versa, and force the lather to the tips of the fingers. Do this procedure 5 times changing hands in each movement.
i) Place all lather in the beaker.
j) Repeat the whole procedure from step “d” to “i” twice more, combining all the lather gathered in the beaker.
k) Stir the combined lather gently to release large pockets of air with plastic stick. Flatten the foam with your fingertip. Read and record the volume.
l) Run the whole procedure, steps “c” to “k”, for each sample in the test. Between one assessment and another, wash well the hands wearing gloves with neutral soap (e.g. a cast melt product or SLS solution 4%), removing any residue of previous sample that could disturb the following assessment.

Note: Gloves may be replaced when they show signs of permanent contamination or wear.

### Bar Feel & Lather Profile

### 1. Principle

Bar Feel & Lather can be profiled by wider range of descriptors, used to emphasize special features on subjective assessments. These descriptors are useful on formulation and processing development, as well as on products quality checking. The bar feel and lather aspects are evaluated accordingly defined qualitative scales, by technicians trained on anchors for each assessment scale.

The bar feel attribute assessed by this protocol is:
Bar Hardness/Firmness before and during use

The lather attribute assessed by this protocol is:
Speed of Lathering

The assessments are conducted by trained technicians without gloves. Some attributes are assessed in two different water temperature: 25° C. and 40° ° C., simulating the average for hand washing and bath. Depending on region under study, other temperatures can be also used on tests.

Usually samples are assessed by two technicians who may have a consensus on reporting the grade of the attribute. (Samples can be assessed by more evaluators).

### 2. Equipments/Facilities Setup/Samples

| | |
|---|---|
| Soap drained dishes | 1 per sample |
| Thermometer | Mercury types are not approved |
| Water temperature set-up | 25° C., 30° C. and 40° C. standard |
| Water hardness set-up | accordingly to region under study |
| Water Flow | 1.5 L/min |
| Metronome (optional) | 150 bpm |
| Samples | 1 bar per evaluator (~2 bars), |
| | of each product tested |

### 3. Procedure

a) Identify all samples on soap dishes with correct codes, accordingly to test form.
b) It is recommended has a 3rd person to record scores during assessments to avoid evaluators break procedures to take notes.
c) Before start the assessments, wash well the hands with neutral soap (e.g. a cast melt product or SLS solution 4%) and dry them.
d) Start assessing Bar Hardness on dry bar (before use), for samples in study:
   Hardness of the bar (Bar Firmness): hold the bar in one hand, and press the thumb on each bar corner. Assess the product by tactile feel, accordingly to scale:

| | | | |
|---|---|---|---|
| 1- Soft | 2- Moderately Soft | 3- Slightly Soft | 4- Hard |

e) Set up water at 25° C. on adequate flow and hardness.
g) Get one samples, wet the hand and wet the bar. Spin it 12 times* outside the water. During movements, assess Speed of Lathering visually, accordingly to scale below:

| | | | | |
|---|---|---|---|---|
| 1- Slow | 2- Slightly Slow | 3- Moderate | 4- Slightly Fast | 5- Fast |

*1 spin = 180° turn on speed of 1 bit in the metronome rhythm 150 bpm.

### Hardness Testing Protocol

### Principle

A 30° conical probe penetrates into a soap/syndet sample at a specified speed to a pre-determined depth. The resistance generated at the specific depth is recorded. There is no size or weight requirement of the tested sample except that the bar/billet be bigger than the penetration of the cone (15 mm) and have enough area. The recorded resistance number is also related to the yield stress and the stress can be calculated as noted below. The hardness (and/or calculated yield stress) can be measured by a variety of different penetrometer methods. In this invention, as noted above, we use probe which penetrates to depth of 15 mm.

### Apparatus and Equipment

### TA-XT Express (Stable Micro Systems)

30° conical probe—Part #P/30c (Stable Micro Systems)

### Sampling Technique

This test can be applied to billets from a plodder, finished bars, or small pieces of soap/syndet (noodles, pellets, or bits). In the case of billets, pieces of a suitable size (9 cm) for the TA-XT can be cut out from a larger sample. In the case of pellets or bits which are too small to be mounted in the TA-XT, the compression fixture is used to form several noodles into a single pastille large enough to be tested.

### Procedure

### Setting Up the TA-XT Express

These settings need to be inserted in the system only once. They are saved and loaded whenever the instrument is turned on again. This ensures settings are constant and that all experimental results are readily reproducible.

### Set Test Method

Press MENU
Select TEST SETTINGS (Press 1)
Select TEST TPE (Press 1)
Choose option 1 (CYCLE TEST) and press OK
Press MENU
Select TEST SETTINGS (Press 1)
Select PARAMETERS (Press 2)
Select PRE TEST SPEED (Press 1)
Type 2 (mm s⁻¹) and press OK
Select TRIGGER FORCE (Press 2)
Type 5 (g) and Press OK
Select TEST SPEED (Press 3)
Type 1 (mm s⁻¹) and press OK
Select RETURN SPEED (Press 4)
Type 10 (mm s⁻¹) and press OK
Select DISTANCE (Press 5)
Type 15 (mm) for soap billets or 3 (mm) for soap pastilles and press OK
Select TIME (Press 6)
Type 1 (CYCLE)

### Calibration

Screw the probe onto the probe carrier.
Press MENU
Select OPTIONS (Press 3)
Select CALIBRATE FORCE (Press 1)—the instrument asks for the user to check whether the calibration platform is clear
Press OK to continue and wait until the instrument is ready.
Place the 2 kg calibration weight onto the calibration platform and press OK
Wait until the message “calibration completed” is displayed and remove the weight from the platform.

### Sample Measurements

Place the billet onto the test platform.
Place the probe close to the surface of the billet (without touching it) by pressing the UP or DOWN arrows.

### Press RUN

Take the readings (g or kg) at the target distance (Fin).
After the run is performed, the probe returns to its original position.
Remove the sample from the platform and record its temperature.

### Calculation & Expression of Results

### Output

The output from this test is the readout of the TA-XT as “force” (Rr) in g or kg at the target penetration distance, combined with the sample temperature measurement. (In the subject invention, the force is measured in Kg at 40° C. at 15 mm distance) The force reading can be converted to extensional stress, according to the equation below: The equation to convert the TX-XT readout to extensional stress is

$$σ = \frac{1}{C} \frac{{R}_{T} {g}_{c}}{A}$$

where: σ=extensional stress
   C=“constraint factor” (1.5 for 30° cone)
   G_{c}=acceleration of gravity
   A=projected area of cone=π(d tan ½θ)²
   d=penetration depth
   θ=cone angle
For a 30° cone at 15 mm penetration Equation 2 becomes

$$σ ( Pa ) = {R}_{T} ( g ) \times 128.8$$

This stress is equivalent to the static yield stress as measured by penetrometer.
The extension rate is

$$\dot{ε} = \frac{V}{d tan ( \frac{1}{2} θ )}$$

where \acute{ε}=extension rate (s⁻¹)
   V=cone velocity
For a 30° cone moving at 1 mm/s, \acute{ε}=0.249 s⁻¹

### Temperature Correction

The hardness (yield stress) of skin cleansing bar formulations is temperature-sensitive. For meaningful comparisons, the reading at the target distance (Rr) should be corrected to a standard reference temperature (normally 40° C.), according to the following equation:

$${R}_{40} = {R}_{T} \times exp [ α ( T - 40 ) ]$$

where R₄₀=reading at the reference temperature (40° C.)
   R_{T}=reading at the temperature T
   α=coefficient for temperature correction
   T=temperature at which the sample was analyzed.

The correction can be applied to the extensional stress.

### Raw and Processed Data

The final result is the temperature-corrected force or stress, but it is advisable to record the instrument reading and the sample temperature also.

1-15. (canceled)

16. A process to produce a soap bar composition, the process comprising the steps of:
a) providing a mixture comprising:
i) fatty acid soap in an amount from 65 to 80 wt % based on total weight of the soap bar produced, wherein C₈-C₁₄ fatty acid soap is present at an amount between 15 and 30 wt %, and further wherein the fatty acid soap comprises 10 to 40 wt % soap derived from palm kernel oil and 60 to 90 wt % soap derived from palm oil, based on total weight of the fatty acid soap;
ii) free fatty acid in an amount from 0.5 to 5 wt % based on total weight of the soap bar produced, wherein the free fatty acids comprise C₁₂ free fatty acid in an amount from 40 to 100 wt % based on total weight of the free fatty acid;
iii) a polyol which is glycerol in an amount from 3 to 5 wt % based total weight of the soap bar produced; and
iv) from 15 to 25 wt % water based on total weight of the soap bar produced,
b) shaping the resulting mixture into a soap bar.

17. The process according to claim 16, wherein the fatty acid soap is added in the form of soap noodles comprising the fatty acid soap, and further wherein the soap noodles comprise less than 8 wt % of glycerol based on the weight of the soap noodles.

18. The process according to claim 16, wherein the glycerol is added in step a) before the fatty acid soap, or before the fatty acid soap and free fatty acid.

19. The process according to claim 16, wherein the free fatty acid is added in the form of C₁₂ fatty acid or in the form of coconut fatty acid.

20. The process according to claim 16, wherein the shaping of the mixture comprises extrusion.

21. The process according to claim 16, wherein glycerin to free fatty acid added are at a weight ratio below 5.

22. A cleansing bar comprising:
i) 65 to 80% of fatty acid soap, wherein C₈ to C₁₄ fatty acid soap is present at an amount between 15 and 30 wt % based on the total weight of the fatty acid soap, and further wherein the fatty acid soap comprises 10 to 40 wt % soap derived from palm kernel oil and 60 to 90 wt % soap derived from palm oil based on the weight of the fatty acid soap;
ii) 0.5 to 5 wt % of free fatty acid, wherein the cleansing bar comprises C₁₂ free fatty acid in an amount of from 40 to 100 wt % based on the weight of the free fatty acid,
iii) a polyol which is glycerol in an amount from 3 to 5 wt % based total weight of the cleansing bar; and
iv) from 15 to 25 wt % of water.

23. The bar according to claim 22, wherein the free fatty acid comprises C₁₂ fatty acid in an amount from 60 to 100 wt %, based on total weight of the free fatty acid.

24. The bar according to claim 22, wherein the free fatty acid is C₁₂ fatty acid.

25. The bar according to claim 22, wherein glycerin to total free fatty acid in the bar are at a weight ratio below 5.

26. The bar according to claim 22, wherein the bar is free from TiO2, ZnO2, ethylene glycol mono- or distearate, zinc stearate, or polyox high molecular weight.

27. The bar according to claim 22, wherein the bar is not opaque.

28. The bar according to claim 22 wherein the bar further comprises an anti-oxidant, perfume, chelating agent, colourant, deodorant, dye, emollient, moisturizer, enzyme, foam booster, germicide, antimicrobial agent, lathering agent, skin conditioner, sunscreen, sodium metabisulphite, ethylene diamine tetra acetic acid, borax or ethylene hydroxy diphosphonic acid or a mixture thereof.
